(19) United States
(12) Patent Application Publication
(10) Pub. No.: US 2024/0343957 A1
(43) Pub. Date: Oct. 17, 2024

(54) HIGH GREEN STRENGTH REACTIVE HOT MELT ADHESIVES

(71) Applicants: Dow Global Technologies LLC, Midland, MI (US); Rohm and Haas Company, Collegeville, PA (US)

(72) Inventors: Wanfu Ma, Shanghai (CN); Xian Jiang, Freeport, TX (US); ChenYan Bai, Shanghai (CN); Fan Fei, Shanghai (CN); Juan C. Tuberquia, Freeport, TX (US); Allan Mclennaghan, Horgen (CH)

(73) Assignees: Dow Global Technologies LLC, Midland, MI (US); Rohm and Haas Company, Collegeville, PA (US)

(21) Appl. No.: 18/293,926

(22) PCT Filed: Aug. 20, 2021
(86) PCT No.: PCT/CN2021/113812

§ 371 Date: Jan. 31, 2024

(51) Int. Cl. C09J 175/08; B32B 7/12; C09J 5/06

(52) U.S. Cl. CPC C09J 175/08; B32B 7/12; C09J 5/06; C09J 2423/04; C09J 2475/00

(57) ABSTRACT

It provides embodiments of a reactive hot melt adhesive. In embodiments, the reactive hot melt adhesive may comprise at least one isocyanate compound, at least one polyester polyol, at least one polyether polyol, and at least one thermoplastic polymer. The at least one thermoplastic polymer may have a viscosity less than 75,000 cP at 177° C. The thermoplastic polymer may comprise ethylene-acrylic-carbon monoxide terpolymer, ethylene-(C₃-C₁₂) alkylene-acrylic-carbon monoxide tetrapolymer, or both.

### TECHNICAL FIELD

Embodiments described herein generally relate to adhesives and, more specifically, relate to reactive hot melt adhesives.

### BACKGROUND

Reactive hot melt adhesives start out as thermoplastic materials that can be repeatedly heated to a molten state and cooled to a solid state. However, when exposed to appropriate conditions, the reactive hot melt adhesive crosslinks and cures to an irreversible solid form. One class of reactive hot melt adhesives are polyurethane hot melt adhesives. Polyurethane reactive (PUR) hot melt adhesives include isocyanate terminated polyurethane pre-polymers that react with surface or ambient atmospheric moisture to chain-extend, forming a new polyurethane/urea polymer. The final adhesive product is a crosslinked material polymerized primarily through urea groups and urethane groups.

Conventional reactive hot melt adhesives can provide excellent final bond strength but are unable to simultaneously provide high green strength, high final bond strength, sufficient open time, and acceptable rheological properties. Green strength refers to the initial strength of the adhesive bond after application of the molten adhesive to a substrate and before full curing. High green strength is desirable as it allows bonded parts to be held together by the adhesive without additional clamps or fasteners. Open time refers to the length of time after application of the adhesive on one substrate before the other substrate must be placed in order to give required bonding strength. A long open time is preferred as it gives time for other process steps to occur.

As such, there is a need for alternative reactive hot melt adhesives, which can provide high green strength, high final bond strength, sufficient open time, and acceptable rheological properties.

### SUMMARY

Embodiments of the present disclosure meet this need by providing a reactive hot-melt adhesive with at least one thermoplastic polymer. The presence of the thermoplastic polymer in the reactive hot melt adhesive provides improved green strength to the adhesive composition while retaining acceptable final bond strength and open time.

According to one or more embodiments of the present disclosure, a reactive hot melt adhesive may comprise at least one isocyanate compound, at least one polyester polyol, at least one polyether polyol, and at least one thermoplastic polymer. The at least one thermoplastic polymer may have a viscosity less than 75,000 cP at 177° C. The thermoplastic polymer may comprise an ethylene-acrylic-carbon monoxide terpolymer, an ethylene-(C₃-C₁₂) alkylene-acrylic-carbon monoxide tetrapolymer, or both.

These and other embodiments are described in more detail in the following Detailed Description.

### DETAILED DESCRIPTION

### Definitions

As used herein, “cP” means centipoise, “C” means degrees Celsius, “mm” means millimeters, “gsm” means grams per square meter, “min.” means minutes, “cSt” means centistokes, “mol” means moles, “kg” means kilograms, “cm2” means square centimeters, “1b” means pounds, “hr” means hours, “g/mol” means grams per mol, “mg” means milligrams.

The term “polymer” refers to a polymeric compound prepared by polymerizing monomers, whether of a same or a different type. The generic term polymer thus embraces the term “homopolymer,” which usually refers to a polymer prepared from only one type of monomer as well as “copolymer,” which refers to a polymer prepared from two or more different monomers. The term “interpolymer,” as used herein, refers to a polymer prepared by the polymerization of at least two different types of monomers. The generic term interpolymer thus includes a copolymer or polymer prepared from more than two different types of monomers, such as terpolymers and tetrapolymers.

As used herein, the term “the total weight of the reactive hot melt adhesive” refers to the total weight of the claimed components of the reactive hot melt adhesive. The total weight of the reactive hot melt adhesive does not include any other components, such as solvents, additives, catalysts, or chain extenders.

### Embodiments

Reference will now be made in detail to embodiments of the reactive hot melt adhesive as described herein. Embodiments of the reactive hot melt adhesive may comprise at least one isocyanate compound, at least one polyester polyol, at least one polyether polyol, and at least one thermoplastic polymer. The at least one thermoplastic polymer may have a viscosity less than 75,000 cP at 177° C. The thermoplastic polymer may comprise an ethylene-acrylic-carbon monoxide terpolymer, an ethylene-(C₃-C₁₂) alkylene-acrylic-carbon monoxide tetrapolymer, or combinations thereof.

Accordingly, the at least one thermoplastic polymer may have a viscosity less than 75,000 cP at 177° C. For example, the at least one thermoplastic polymer may have a viscosity of less than 70,000 cP, less than 60,000 cP, from 2,000 to 70,000 cP, from 2,000 to 60,000 cP, from 2,000 to 50,000 cP, from 5,000 to 30,000 cP, from 25,000 to 70,000 cP, from 25,000 to 50,000 cP, or from 25,000 to 40,000 cP, or any subset thereof, at 177° C. Viscosity is measured according to the Brookfield Viscosity method, a modified version of ASTM D3236.20832, as described in further detail below. Without being limited by theory, it is believed that the viscosity of the thermoplastic polymer provides the desired processability of the reactive hot melt adhesive results, while also achieving improved green strength.

As discussed above, the present thermoplastic polymer may comprise an ethylene-acrylic-carbon monoxide terpolymer, an ethylene-(C₃-C₁₂) alkylene-acrylic-carbon monoxide tetrapolymer, or combinations thereof.

In embodiments where the thermoplastic polymer is a terpolymer or tetrapolymer, the terpolymer or tetrapolymer may comprise polymer units-(CH₂CH₂)-derived from ethylene monomer. The terpolymer or tetrapolymer may include from 25 wt. % to 90 wt. % of ethylene monomer based on the total weight of the terpolymer or tetrapolymer. For example, the terpolymer or tetrapolymer may comprise from 25 wt. % to 80 wt. %, from 25 wt. % to 70 wt. %, from 25 wt. % to 60 wt. %, from 25 wt. % to 50 wt. %, from 25 wt. % to 40 wt. %, from 25 wt. % to 30 wt. %, from 30 wt. % to 90 wt. %, from 30 wt. % to 80 wt. %, from 30 wt. % to 70 wt. %, from 30 wt. % to 60 wt. %, from 30 wt. % to 50 wt. %, from 30 wt. % to 40 wt. %, from 40 wt. % to 90 wt. %, from 40 wt. % to 80 wt. %, from 40 wt. % to 70 wt. %, from 40 wt. % to 60 wt. %, from 40 wt. % to 50 wt. %, from 50 wt. % to 90 wt. %, from 50 wt. % to 80 wt. %, from 50 wt. % to 70 wt. %, from 50 wt. % to 60 wt. %, from 60 wt. % to 90 wt. %, from 60 wt. % to 80 wt. %, from 60 wt. % to 70 wt. %, from 70 wt. % to 90 wt. %, from 70 wt. % to 80 wt. %, or from 80 wt. % to 90 wt. %, or any subset thereof, of polymer units derived from ethylene monomers. It should be understood that the given ranges describe one or more individual terpolymers or tetrapolymers. Although multiple thermoplastic polymers may be present in a single composition, the ranges are not intended to describe an additive or average concentration across multiple polymers.

In embodiments where the thermoplastic polymer is a terpolymer or tetrapolymer, the terpolymer or tetrapolymer may also comprise polymer units derived from an acrylate. For example, the acrylate may be an alkyl acrylate, such as methyl acrylate, ethyl acrylate, butyl acrylate, or combinations thereof. The terpolymer or tetrapolymer may comprise from 5 wt. % to 40 wt. % of polymer units derived from acrylate, based on the total weight of the terpolymer or tetrapolymer. For example, the terpolymer or tetrapolymer may comprise from 5 wt. % to 35 wt. %, from 5 wt. % to 30 wt. %, from 5 wt. % to 25 wt. %, from 5 wt. % to 20 wt. %, from 5 wt. % to 15 wt. %, from 5 wt. % to 10 wt. %, from 10 wt. % to 40 wt. %, from 10 wt. % to 35 wt. %, from 10 wt. % to 30 wt. %, from 10 wt. % to 25 wt. %, from 10 wt. % to 20 wt. %, from 10 wt. % to 15 wt. %, from 15 wt. % to 40 wt. %, from 15 wt. % to 35 wt. %, from 15 wt. % to 30 wt. %, from 15 wt. % to 25 wt. %, from 15 wt. % to 20 wt. %, from 20 wt. % to 40 wt. %, from 20 wt. % to 35 wt. %, from 20 wt. % to 30 wt. %, from 20 wt. % to 25 wt. %, from 25 wt. % to 40 wt. %, from 25 wt. % to 35 wt. %, from 25 wt. % to 30 wt. %, from 30 wt. % to 40 wt. %, from 30 wt. % to 35 wt. %, or from 35 wt. % to 40 wt. %, or any subset thereof, of polymer units derived from acrylate. It should be understood that the given ranges describe one or more individual terpolymers or tetrapolymers. Although multiple thermoplastic polymers may be present in a single composition, the ranges are not intended to describe an additive or average concentration across multiple polymers.

In embodiments where the thermoplastic polymer is a terpolymer or tetrapolymer, the terpolymer or tetrapolymer may further comprise polymer units derived from carbon monoxide. The terpolymer or tetrapolymer may include from 3 wt. % to 30 wt. % of CO based polymer units, based on the total weight of the terpolymer or tetrapolymer. For example, the terpolymer or tetrapolymer may include from 3 wt. % to 25 wt. %, from 3 wt. % to 20 wt. %, from 3 wt. % to 15 wt. %, from 3 wt. % to 10 wt. %, from 3 wt. % to 5 wt. %, from 5 wt. % to 30 wt. %, from 5 wt. % to 25 wt. %, from 5 wt. % to 20 wt. %, from 5 wt. % to 15 wt. %, from 5 wt. % to 10 wt. %, from 10 wt. % to 30 wt. % from 10 wt. % to 25 wt. %, from 10 wt. % to 20 wt. %, from 10 wt. % to 15 wt. %, from 15 wt. % to 30 wt. %, from 15 wt. % to 25 wt. %, from 15 wt. % to 20 wt. %, from 20 wt. % to 30 wt. %, from 20 wt. % to 25 wt. %, from 25 wt. % to 30 wt. %, or any subset thereof, of CO derived polymer units. It should be understood that the given ranges describe one or more individual terpolymers or tetrapolymers. Although multiple thermoplastic polymers may be present in a single composition, the ranges are not intended to describe an additive or average concentration across multiple polymers.

In embodiments where the thermoplastic polymer is a tetrapolymer, the thermoplastic polymer may include polymer units derived from a (C₃-C₁₂) alkylene monomer. For example, the polymer units derived from (C₃-C₁₂) alkylene may be derived from C₃ to C₁₀ alkylene, C₃ to C₈ alkylene, C₃ to C₅ alkylene, C₃ to C₄ alkylene, C₄ to C₁₂ alkylene, C₄ to C₁₀ alkylene, C₄ to C₈ alkylene, C₄ to C₆ alkylene, or any combination thereof. In some embodiments, the polymer units derived from (C₃-C₁₂) alkylene may be derived from propylene.

The tetrapolymer may comprise from 0.1 to 5 wt. % of polymer units derived from (C₃-C₁₂) alkylene, based on the total weight of the tetrapolymer. For example, the tetrapolymer may include from 0.1 wt. % to 4 wt. %, from 0.1 wt. % to 3 wt. %, from 0.1 wt. % to 2 wt. %, from 0.1 wt. % to 1 wt. %, from 0.5 wt. % to 5 wt. %, from 1 wt. % to 5 wt. %, from 2 wt. % to 5 wt. %, from 3 wt. % to 5 wt. %, from 1 wt. % to 4 wt. %, from 2 wt. % to 3 wt. %, or any subset thereof of alkylene. It should be understood that the given ranges describe one or more individual tetrapolymers. Although multiple thermoplastic polymers may be present in a single composition, the ranges are not intended to describe an additive or average concentration across multiple polymers.

In embodiments where the thermoplastic polymer is a terpolymer, the ethylene acrylic carbon-monoxide terpolymer may comprise from 25 wt. % to 90 wt. % of ethylene, from 5 wt. % to 40 wt. % of alkyl acrylate, and from 3 wt. % to 30 wt. % of carbon monoxide (CO).

In embodiments where the thermoplastic polymer is a tetrapolymer, the tetrapolymer may comprise from 25 wt. % to 90 wt. % of ethylene, from 0.1 wt. % to 5.0 wt. % of alkylene, from 5 wt. % to 40 wt. % of alkyl acrylate, and from 3 wt. % to 30 wt. % of carbon monoxide (CO). In some embodiments, the alkylene may be propylene. Thus, the ethylene-(C₃-C₁₂) alkylene-acrylic-carbon monoxide tetrapolymer may be ethylene-propylene-acrylic-carbon monoxide tetrapolymer

The reactive hot melt adhesive may comprise from 5 to 30 wt. % of the at least one thermoplastic polymer, based on the total weight of reactive hot melt adhesive. For example, the reactive hot melt adhesive may comprise from 5 to 25 wt. %, from 5 to 20 wt. %, from 5 to 15 wt. %, from 10 to 30 wt. %, from 10 to 25 wt. %, from 10 to 20 wt. %, or any subset thereof, of the at least one thermoplastic polymer. Without being limited by theory, there is believed to be a tradeoff between final strength and green strength. Additional thermoplastic polymer is believed to improve green strength but decrease final strength. Further, the quantity of thermoplastic polymer in the reactive hot melt adhesive may be limited by the viscosity or melt index of the thermoplastic polymer available.

The reactive hot melt adhesive may include at least one isocyanate compound. The isocyanate compound may comprise one or more isocyanate groups. The isocyanate compound may be monomeric or non-monomeric. A “monomeric isocyanate” is a compound that has one or more isocyanate groups, and that has no urethane linkage and no urea linkage. Any isocyanate that is not a monomeric isocyanate is a non-monomeric isocyanate. According to some embodiments, the isocyanate compound may comprise 2 or at least 2 isocyanate groups.

The isocyanate compound may comprise from 20 to 40 wt. % isocyanate groups. For example, the isocyanate compound may comprise from 20 to 35 wt. %, from 20 to 30 wt. %, from 25 to 40 wt. %, from 30 to 40 wt. %, from 25 to 35 wt. %, or any subset thereof, of isocyanate groups.

The isocyanate compound may be an aromatic isocyanate. For example, the isocyanate compound may comprise phenyl groups and isocyanate groups. The isocyanate compound may comprise an equal number of phenyl and isocyanate groups, such as 2 phenyl and 2 isocyanate groups. In specific embodiments, the isocyanate compound may comprise diphenyl-methane di-isocyanate. Suitable isocyanate compounds include ISONATE™ available from Dow Inc, Midland, MI.

The reactive hot melt adhesive may comprise from 10 to 30 wt. % of the at least one isocyanate compound, based on the total weight of the reactive hot melt adhesive. For example, the reactive hot melt adhesive may comprise from 10 to 25 wt. %, from 10 to 20 wt. %, from 15 to 30 wt. %, from 20 to 30 wt. %, from 15 to 25 wt. %, or any subset thereof, of the at least one isocyanate compound.

The reactive hot melt adhesive may comprise at least one polyester polyol. As used herein, a “polyester polyol” is a compound which comprises multiple hydroxyl groups and multiple ester groups. Without being limited by theory, it is believed that the polyester polyols may react with the isocyanate compounds to form polyurethanes. The polyester polyol may have an average molecular weight of from 3000 to 5000 g/mol, from 3500 to 4500 g/mol, or from 3800 to 4200 g/mol. The polyester polyol may have a hydroxyl content equivalent of from 20 to 40 mg KOH/g, from 25 to 35 mg KOH/g, or from 26 to 30 mg KOH/g. The polyester polyol may have a functionality of from 1-3, such as 2. The polyester polyol may be a polycaprolactone polyol. Suitable polycaprolactone polyols include CAPA™ 2402 from Perstorp.

The reactive hot melt adhesive may comprise from 2 to 15 wt. % of the at least one polyester polyol, based on the total weight of the reactive hot melt adhesive. For example, the reactive hot melt adhesive may comprise from 2 to 12 wt. %, from 2 to 10 wt. %, from 4 to 15 wt. %, from 6 to 15 wt. %, from 8 to 15 wt. %, from 4 to 13 wt. %, or any subset thereof, of the at least one polyester polyol.

The reactive hot melt adhesive may comprise at least one polyether polyol. As used herein, a “polyether polyol” may be a compound with multiple hydroxyl groups and multiple ether linkages. The polyether polyol may comprise a polyether triol with an average molecular weight of from 4500 to 5500 g/mol; an average kinematic viscosity of from 800 to 900 cSt, such as 840 cSt; an average OH number of 30 to 35 mg KOH/g, such as 33 mg KOH/g, and a nominal functionality of from 2 to 4, such as 3. Alternatively, the polyether polyol may comprise a homopolymer diol with an average molecular weight of 1800 to 2200 g/mol; an average OH number of 50 to 60 mg KOH/mol, such as 56 mg KOH/mol; an average kinematic viscosity of 250 to 375 cSt, such as 320 cSt; and a nominal functionality of 1-3, such as 2. The at least one polyether polyol may comprise both the polyether triol and the homopolymer diol. Suitable polyether polyols may include VORANOL™ 4701 and VORANOL™ PPG2000 available from Dow Inc, Midland, MI.

The reactive hot melt adhesive may comprise from 50 to 70 wt. % of the at least one polyether polyol, based on the total weight of the reactive hot melt adhesive. For example, the reactive hot melt adhesive may comprise from 50 to 65 wt. %, from 50 to 60 wt. %, from 55 to 70 wt. %, from 60 to 70 wt. %, or any subset thereof, of the polyether polyol.

The reactive hot melt adhesive may include additional components, such as those useful for promoting polymerization. For example, the reactive hot melt adhesive may include a chain extender. Chain extenders may be useful to create urethane or urea linkages. Suitable chain extenders for the present application may include those that create urethane linkages, such as ethylene glycol, butane diol, and dipropylene glycol. The reactive hot melt adhesive may comprise from 0 to 5 wt. % of the chain extender, based on the total weight of the at least one isocyanate compound, at least one polyester polyol, at least one polyether polyol, and at least one thermoplastic polymer. For example, the reactive hot melt adhesive may comprise from 1 to 5 wt. %, from 2 to 5 wt. %, from 0.1 to 4 wt. %, from 0.1 to 3 wt. %, from 1 to 4 wt. %, or any subset thereof, of the chain extender.

Embodiments of the present disclosure are directed to reactive hot melt adhesive compounds which have improved green strength and open time, while maintaining rheological properties and final bond strength. As discussed above, green strength (also referred to as green bond strength) describes the strength of an adhesive bond before it has had time to start curing. The reactive hot melt adhesive may have a green strength of at least 10 N/15 mm. For example, the green strength may be at least 11 N/15 mm, at least 12 N/15 mm, at least 13 N/15 mm, at least 14 N/15 mm, at least 15 N/15 mm, or at least 30 N/15 mm. Green bond strength may be determined according to the procedure described below.

As discussed above, open time describes how long it allows to place the second substrate after application of an adhesive onto the first substrate. The reactive hot melt adhesive may have an open time of at least 1 minute, at least 2 minutes, at least 5 minutes, at least 10 minutes, at least 15 minutes, or at least 20 minutes. Open time may be determined according to the procedure described below.

Final strength refers to the strength of an adhesive bond after it has had sufficient time to cure. The reactive hot melt adhesive may have a final strength of at least 400 N/15 mm, at least 450 N/15 mm, at least 475 N/15 mm, or at least 500 N/15 mm. Final strength may be determined according to the procedure described below.

The reactive hot melt adhesive may have a viscosity of less than 10,000 cP at application temperature. For example the reactive hot melt adhesive may have a viscosity at application temperature of less than 9000 cP, less than 8000 cP, less than 7000 cP, less than 6000 cP, less than 5000 cP, less than 4000 cP, less than 3000 cP, from 500 to 10,000 cP, from 500 to 7000 cP, from 500 to 5000 cP, from 500 to 3000 cP, or any subset thereof. The application temperature may be 121° C. Viscosity may be determined according to the method described below.

According to some embodiments, the reactive hot melt adhesive may optionally include less than 1 wt. %, less than 0.1 wt. %, or less than 0.001 wt. % of a hydroxyl containing, or a nonreactive polymer formed from ethylenically unsaturated monomers.

According to some embodiments, the reactive hot melt adhesive may optionally include less than 1 wt. %, less than 0.1 wt. %, or less than 0.001 wt. % of a tackifying resin. The tackifying resin may comprise a non-polar polyol, such as those having a hydroxyl number of less than 50. The tackifying resin may be a reactive tackifying resin.

According to some embodiments, the reactive hot melt adhesive may optionally include less than 1 wt. %, less than 0.1 wt. %, or less than 0.001 wt. % of an acrylic block copolymer.

According to some embodiments, the reactive hot melt adhesive may optionally include less than 1 wt. %, less than 0.1 wt. %, or less than 0.001 wt. % of an thermoplastic polyurethane.

The reactive hot melt adhesive of the present disclosure may be incorporated into articles, such as bonded structures. In some embodiments, a bonded structure may comprise at least two substrates adhered together by the reactive hot melt adhesive of the present disclosure.

### Test Methods

### Viscosity

Viscosity is measured according to the Brookfield viscosity test method, a modified version of ASTM D3236.20832. Viscosity is measured in a Brookfield Laboratories DVII+Viscometer and disposable aluminum sample chambers. The spindle used, is a SC-31 hot-melt spindle, suitable for measuring viscosities in the range of from 10 to 100,000 centipoise. The sample is poured into the chamber, which is in turn, inserted into a Brookfield Thermosel, and locked into place. The sample chamber has a notch on the bottom that fits the bottom of the Brookfield Thermosel to ensure that the chamber does not turn when the spindle is inserted and spinning. The sample is heated to the measurement temperature (177° C. unless otherwise indicated), until the melted sample is about 2.54 cm (1 inch) (approximately 8 grams of resin) below the top of the sample chamber. The viscometer apparatus is lowered and the spindle submerged into the sample chamber. Lowering is continued until brackets on the viscometer align on the Thermosel. The viscometer is turned on, and set to operate at a shear rate which leads to a torque reading in the range of 30 to 60 percent. Readings are taken every minute for about 15 minutes, or until the values stabilize, at which point, a final reading is recorded.

### Open Time

Open time was tested using the following steps: 1) preheating the adhesive to 121° C., 2) coating the adhesive onto a flat wooden strip, 3) placing a second wooden strip onto the adhesive, 4) cooling down both strips to 25° C., and 5) separating the two wooden strips. Upon separating the two strips, check whether there is adhesive residue on the second wooden strip. The last time at which no residue is left on the second strip is the open time.

### Green Bond Strength

Green bond strength was tested using the following steps: 1) preheat adhesive to 121° C., 2) coat adhesive onto 15 mm width wooden strips immediately with a loading of 220 gsm, 3) place a second wooden strip on the adhesive zone, 4) allow the sample to rest for 30 min., 5) pull test the sample. The shear strength of the sample is tested on an Instron 5940 machine with 250 mm/min speed.

### Final Bond Strength

Final bond strength was tested using the following steps: 1) preheat adhesive to 121° C., 2) coat adhesive onto 15 mm width wooden strips immediately with a loading of 220 gsm, 3) place a second wooden strip on the adhesive zone, 4) allow the sample to rest at 25° C. for 7 days, 5) test the sample. The shear strength of the sample is tested on an Instron 5940 machine with 250 mm/min speed.

### EXAMPLES

The following examples illustrate features of the present disclosure but are not intended to limit the scope of the disclosure. The following experiments analyzed the performance of embodiments of the polymer compositions described herein.

### Example 1: Thermoplastic Polymer Preparation

Three thermoplastic polymers labeled EPBACO (a tetrapolymer), EBACO 1 (a terpolymer), and EBACO 2 (a terpolymer) were prepared. To prepare the thermoplastic polymers, a 545 milliliter (mL) stirred autoclave was charged with a mixture of ethylene (E), n-butyl acrylate (nBA), carbon monoxide (CO), and either acetone or propylene (as indicated in Table 1 below). A 1 wt. % to 3 wt. % solution of organic peroxide (t-butyl peroctoate) in odorless mineral spirits was added as a polymerization initiator to the mixture. The reactor was configured with a pressure set point of approximately 27,000 psi (1,898 kg/cm2) and a target temperature of 205° C. Under the polymerization conditions shown in Table 1, the thermoplastic polymers were continuously synthesized and subsequently converted into pellet form by melt extrusion. The conditions listed in Table 1 are averages over the time span that the polymers were collected.

TABLE 1
Polymerization Conditions

| | EPBACO | EBACO 1 | EBACO 2 |
|---|---|---|---|
| Reactor Pressure (psi) | 27,000 | 27,000 | 27,000 |
| Reactor Temp. (° C.) | 204.9 | 205 | 204.9 |
| Ethylene feed rate (lb/hr) | 24.96 | 25 | 24.9 |
| nBA feed rate (lb/hr) | 1.7 | 1.7 | 1.70 |
| CO feed rate (lb/hr) | 0.71 | 0.68 | 0.69 |
| Acetone Feed Rate (lb/hr) | — | 2.21 | 2.80 |
| Propylene feed rate (lb/hr) | 2.08 | — | — |
| Initiator solution wt. % | 3 | 1 | 3 |
| Initiator solution feed rate | 30.18 | 33.25 | 12.4 |
| (cc/hr) | | | |
| Reactor conversion (%) | 11.40% | 12.30% | 11.1 |

The formulation of each of the synthesized thermoplastic polymers is provided in Table 2 below, where “E” represents ethylene, “nBA” represents n-butyl acrylate; “CO” represents carbon monoxide; and “P” represents propylene. The weight percent of E, nBA, CO, and P are based on the total weight of polymer. Additionally, viscosity and melt index measurements were taken on the synthesized thermoplastic polymers. The conditions and results are given in Table 3 or are as otherwise described in the Test Methods section. Viscosity was measured at 177° C.

TABLE 2
Properties of Thermoplastic Polymers

| | wt. % E | wt. % nBA | wt. % CO | wt. % P |
|---|---|---|---|---|
| EPBACO | 56.6 | 32.2 | 9.0 | 2.2 |
| EBACO 1 | 60.2 | 30.8 | 9.0 | — |
| EBACO 2 | 60.2 | 30.6 | 9.2 | — |

TABLE 3
Rheology Conditions and Measurements

| | RPM | Viscosity (cP) | Torque (%) | Shear Rate (s⁻¹) |
|---|---|---|---|---|
| EBACO 1 | 0.3 | 51,289 | 51.3 | 0.1 |
| EBACO 2 | 0.6 | 26,644 | 53.3 | 0.2 |
| EPBACO | 0.3 | 59,087 | 59.1 | 0.1 |

### Example 2: Preparation of Reactive Hot Melt Adhesives

Inventive and comparative reactive hot melt adhesives were prepared using the materials listed in Table 4.

TABLE 4
Materials List

| Product | | |
|---|---|---|
| Name | Properties | Source |
| ISONATE ™ | Isocyanate NCO = 33% | Dow |
| 125M | | Inc |
| VORANOL ™ | Polyether polyol, Mn = 5000, f = 3, OH = | Dow |
| 4701 | 34 mg KOH/g | Inc |
| VORANOL ™ | Polyether polyol, Mn = 2000, f = 2, OH = | Dow |
| PPG2000 | 56 mg KOH/g | Inc |
| Capa 2402 | Polycaprolactone polyol, Mn = 4000, f = 2, | Perstorp |
| | OH = 28 mg KOH/g (polyester polyol) | |
| Dipropylene | Chemical reagent, Chain Extender | Dow |
| glycol (DPG) | | Inc |
| EBACO 1 | Ethylene- Acrylic-Carbon Monoxide | N/A |
| | Terpolymer | |
| EBACO 2 | Ethylene- Acrylic-Carbon Monoxide | N/A |
| | Terpolymer | |
| EPBACO | Ethylene-Propylene- Acrylic-Carbon Monoxide | N/A |
| | Tetrapolymer | |

First, the generic polyurethane reactive (PUR) formulation in Table 5 was prepared according to the following method: 1) preheat all raw materials in 50° C. oven overnight, 2) introduce VORANOL™ 4701, VORANOL™ PPG2000, Capa 2402, and DPG into reactor tank, and begin agitation, 3) introduce ISONATE™ 125M and continue to agitate for 30 minutes, 4) raise temperature to 80° C., 5) hold at 80° C. for 3 hours, then stop the reaction. The PUR components were mixed in the concentrations given in Table 5.

TABLE 5
Generic PUR formulation

| | |
|---|---|
| ISONATE ™ 125M | 22 wt. % |
| VORANOL ™ 4701 | 37 wt. % |
| VORANOL ™ PPG2000 | 28 wt. % |
| Capa 2402 | 10 wt. % |
| DPG | 3 wt. % |

The generic PUR of Table 5 was then blended with the thermoplastic polymer at 80° C. for one hour. The PUR and thermoplastic polymer were combined in the ratios given in Table 6. Four inventive examples (IE 1-4) and one comparative example (CE 1) were prepared. The compositions listed in Table 6 were applied onto wood strips and were tested according to the testing methodologies described above for open time, green strength, and final strength.

TABLE 6
Adhesive Compositions

| | IE 1 | IE 2 | IE 3 | IE 4 | CE 1 |
|---|---|---|---|---|---|
| Generic PUR (wt. %) | 80 | 80 | 90 | 80 | 100 |
| EBACO 1 (wt. %) | 20 | — | — | — | — |
| EBACO 2 (wt. %) | — | 20 | 10 | — | — |
| EPBACO (wt. %) | — | — | — | 20 | |

TABLE 7
Test Results

| | IE 1 | IE 2 | IE 3 | IE 4 | CE 1 |
|---|---|---|---|---|---|
| Viscosity at 121° C. (cP) | 2615 | 2022 | 1527 | 2459 | 825 |
| Open time | >10 min | >10 min | >10 min | >10 min | >10 min |
| Green Strength (N/15 | 14.1 | 34.3 | 15.8 | 12.2 | 9.5 |
| mm) | | | | | |
| Final Strength (N/15 | 509 | 478 | 578 | 491 | 585 |
| mm) | | | | | |

As is shown in Table 7, all inventive examples have higher green strength than the benchmark CE 1. Inventive IE 2 has the highest green strength, at over 3 times of that of CE 1. In addition, the viscosity at the application temperature (121° C.) of all the inventive samples is low enough and the open times are all long enough for the inventive examples to meet operational requirements. Further, final strength was still maintained at about 80% of CE 1 or higher, despite the significant increase in green strength

It will be apparent that modifications and variations are possible without departing from the scope of the disclosure defined in the appended claims. More specifically, although some aspects of the present disclosure are identified herein as preferred or particularly advantageous, it is contemplated that the present disclosure is not necessarily limited to these aspects.

1. A reactive hot melt adhesive comprising:
at least one isocyanate compound;
at least one polyester polyol;
at least one polyether polyol; and
at least one thermoplastic polymer having a viscosity less than 75,000 cP at 177° C., wherein the thermoplastic polymer comprises an ethylene-acrylic-carbon monoxide terpolymer, an ethylene-(C₃-C₁₂) alkylene-acrylic-carbon monoxide tetrapolymer, or both.

2. The reactive hot melt adhesive of claim 1, wherein the at least one thermoplastic polymer has a viscosity of 2,000 to 70,000 cP at 177° C.

3. The reactive hot melt adhesive of claim 1, wherein the at least one thermoplastic polymer has a viscosity of 5,000 to 30,000 cP at 177° C.

4. The reactive hot melt adhesive of claim 1, wherein the ethylene acrylic carbon-monoxide terpolymer comprises from 25 wt. % to 90 wt. % of ethylene, from 5 wt. % to 40 wt. % of alkyl acrylate, and from 3 wt. % to 30 wt. % of carbon monoxide (CO).

5. The reactive hot melt adhesive of claim 1, wherein the tetrapolymer comprises from 25 wt. % to 90 wt. % of ethylene, from 0.1 wt. % to 5.0 wt. % of (C₃-C₁₂) alkylene, from 5 wt. % to 40 wt. % of alkyl acrylate, and from 3 wt. % to 30 wt. % of carbon monoxide (CO).

6. The reactive hot melt adhesive of claim 4, wherein the alkyl acrylate comprises methyl acrylate, ethyl acrylate, butyl acrylate, or combinations thereof.

7. The reactive hot melt adhesive of claim 1, wherein the ethylene-(C₃-C₁₂) alkylene-acrylic-carbon monoxide tetrapolymer comprises ethylene-propylene-acrylic-carbon monoxide tetrapolymer.

8. The reactive hot melt adhesive of claim 1, wherein the reactive hot melt adhesive comprises from 5 to 30 wt. % of the at least one thermoplastic polymer.

9. The reactive hot melt adhesive of claim 1, wherein the reactive hot melt adhesive comprises from 10 to 30 wt. % of the at least one isocyanate compound.

10. The reactive hot melt adhesive of claim 1, wherein the reactive hot melt adhesive comprises from 2 to 15 wt. % of the at least one polyester polyol.

11. The reactive hot melt adhesive of claim 1, wherein the reactive hot melt adhesive comprises from 50 to 70 wt. % of the at least one polyether polyol.

12. The reactive hot melt adhesive of claim 1, wherein the reactive hot melt adhesive has an open time of at least one minute.

13. A bonded structure comprising at least two substrates adhered together by the reactive hot melt adhesive of claim 1.

14. The reactive hot melt adhesive of claim 5, wherein the alkyl acrylate comprises methyl acrylate, ethyl acrylate, butyl acrylate, or combinations thereof.
